(19) United States
(12) Patent Application Publication
(10) Pub. No.: US 2026/0309561 A1
(43) Pub. Date: Oct. 8, 2026

(54) Measurement Device, Electromechanical Actuator End Piece, Electromechanical Actuator and Association Manufacturing Method

(71) Applicant: Meggitt (Sensorex), Archamps (FR)

(72) Inventor: Raphaël Lattion, Saint-Julien-en-Genevois (FR)

(21) Appl. No.: 19/480,110

(22) PCT Filed: Mar. 25, 2024
(86) PCT No.: PCT/EP2024/057995

§ 371 Date: Oct. 30, 2025

(30) Foreign Application Priority Data
May 15, 2023 (FR) FR2304778

(51) Int. Cl. G01L 5/00; B64D 45/00

(52) U.S. Cl. CPC G01L 5/0028; B64D 45/00; B64D 2045/0085

(57) ABSTRACT

The present invention relates to a measurement device (15) for an electromechanical actuator (1), notably for an aircraft, the electromechanical actuator (1) comprising:

an electric motor (3) arranged in the metal structure (5),

a movable member (9) configured to be moved by the electric motor (3),

the measurement device (15) being configured to be arranged in the metal structure (5) of the electromechanical actuator (1) and comprising:

a position sensor (25) for detecting the position of the movable member (9),

a force sensor (27) configured to measure the force applied by the electromechanical actuator (1) and

a processing unit (35) for processing signals from the position sensor (25) and/or from the force sensor (27).

Title of the invention: measurement device, electromechanical actuator end piece, electromechanical actuator and associated manufacturing method The present invention relates to a measurement device for an electromechanical actuator and, notably, for electromechanical actuators for aircraft. The present invention also relates to an actuator end piece and an actuator comprising such a measurement device and an associated manufacturing method.

Aircraft use numerous actuators. These actuators are used to adjust the position of elements, notably directional elements such as ailerons or deflectors. Sensors such as position sensors or force sensors are associated with these actuators in order to enable the desired position of the element to be obtained. Some elements can be connected to a plurality of actuators acting in parallel, whether due to the size of the element or to obtain redundancy of the actuators and thus to increase safety. Thus it is appropriate to control the different actuators in a suitable manner in order to avoid a deformation such as a twisting of the elements to be actuated.

In order to obtain the aforementioned features while ensuring a maximum reliability of these actuators, the importance thereof being crucial due to the fact that they directly influence the safety of passengers, until now hydraulic actuators have been favored by aircraft manufacturers and suppliers since the hydraulic parts can be easily put into inactive and passive mode in order to enable redundancy in the case of a malfunction of one of the two actuators arranged in parallel.

However, in order to limit the energy consumption of the aircraft, nowadays the tendency is to reduce the weight of the aircraft to a maximum extent. More specifically, hydraulic actuators have a significant weight so that aircraft manufacturers seek solutions to reduce the weight of these actuators.

One solution is to use electromechanical actuators, which in some cases also have to operate in parallel like hydraulic actuators so that it is appropriate to be able to measure accurately the force applied by each actuator. Moreover, electromechanical actuators use mechanical connections, such as screw-nut assemblies, which could seize before reaching the estimated service life of the aircraft (generally 25 or 30 years) due to the number of cycles to be applied and stresses undergone (micro-movements, vibrations, thermal cycles, humidity).

In order to make an electromechanical actuator suitable for aeronautical use, it thus is appropriate to find a solution enabling the service life of the actuator to be maximized and/or the mean time before failure to be maximized (“Mean Time Before Failure (MTBF)” in English) in order to be able to detect the signs of a seizure of the actuator before a malfunction or failure of the actuator is reached and to limit a mechanical overload which the electromechanical actuator could apply to the element of the structure of the aircraft.

The present invention thus aims to provide a solution which enables a reliable actuator to be obtained, the weight thereof being reduced.

To this end, the present invention relates to a measurement device for an electromechanical actuator, notably for an aircraft, said electromagnetic actuator comprising:
an electric motor arranged in a metal structure,
a movable member configured to be moved by the electric motor,
the measurement device being configured to be arranged in the metal structure of the electromagnetic actuator and comprising:
a position sensor for detecting the position of the movable member,
a force sensor configured to measure the force applied by the electromechanical actuator and
a processing unit for processing signals from the position sensor and/or from the force sensor.

The use of a processing unit for processing signals from position sensors and/or force sensors integrated in the structure of the electromechanical actuator makes it possible to increase the accuracy of the measurements, to simplify the transmission of the measurements to the outside of the actuator and to limit the number and the length of the cables necessary for the operation of the electromechanical actuator.

According to a further aspect of the present invention, the measurement device also comprises a temperature sensor and the processing unit is also configured to process signals from the temperature sensor.

According to a further aspect of the present invention, the movement sensor is a variable differential transformer comprising a plurality of coils forming a primary winding and two secondary windings, a ferromagnetic core, which is configured to be moved with the movable member, being arranged in the center thereof.

According to a further aspect of the present invention, the force sensor comprises a plurality of strain gauges arranged on at least one test body which is configured to be deformed as a function of the force applied by the electromagnetic actuator.

According to a further aspect of the present invention, the at least one test body is formed directly in the metal structure of the electromagnetic actuator.

According to a further aspect of the present invention, the processing unit is configured to apply a thermal compensation to the measurements of the position sensor and/or force sensor in order improve the measurement accuracies.

According to a further aspect of the present invention, the processing unit is arranged in a hermetic or sealed housing of the metal structure in order to improve the reliability.

According to a further aspect of the present invention, the measurement device comprises a hermetic connection or a hermetic connector which is configured to provide an electrical connection between the processing unit and the outside of the metal structure, said hermetic connection or said hermetic connector comprising a seal with glass beads.

According to a further aspect of the present invention, the processing unit is configured to calibrate digitally the position sensor and/or force sensor and/or temperature sensor by carrier current via the power supply cables of the processing unit in order to limit the number of cables between the processing unit and the outside of the metal structure.

According to a further aspect of the present invention, the processing unit is configured to apply a self-test of the position sensor and/or the force sensor in order to verify the correct operation thereof in response to the reception of an external command.

The present invention also relates to an electromechanical actuator end piece comprising a first part of the metal structure of the electromechanical actuator in which a measurement device is arranged, as described above.

According to a further aspect of the present invention, the first part comprises a hermetic or sealed housing.

According to a further aspect of the present invention, the end piece comprises a metal cover which is configured to close the hermetic or sealed housing, said metal cover being welded to the first part of the metal structure.

The present invention also relates to an electromechanical actuator comprising:
an electric motor arranged in a metal structure,
a movable member configured to be moved by the electric motor,
an electromagnetic actuator end piece as described above,
a second part of the metal structure.

The present invention also relates to a manufacturing method for manufacturing an electromechanical actuator end piece as described above, comprising a machining step for machining the metal structure to form one or more zones forming a test body which is configured to receive the strain gauges.

Manufacturing method for manufacturing an electromechanical actuator end piece as described above, comprising a welding step for welding the metal cover to the metal structure, notably by electron beam or laser welding.

Further advantages and features will become apparent from reading the description of several illustrative but non-limiting examples of the present invention, in addition to the accompanying drawings, in which:

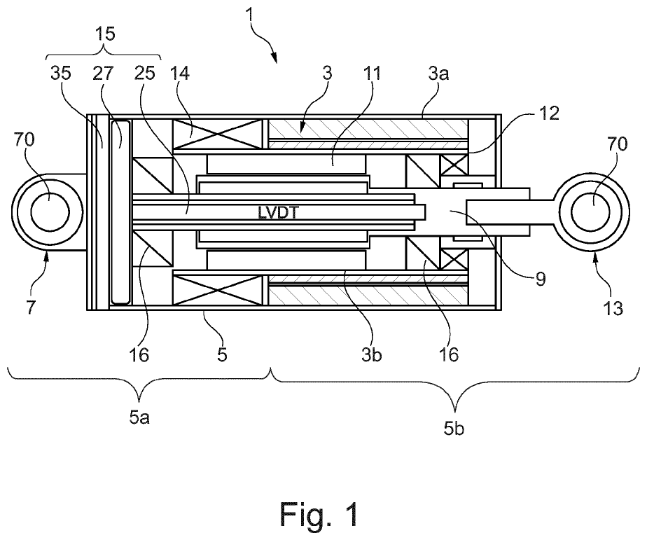

FIG. 1 is a view in section of an electromechanical actuator according to the present invention;

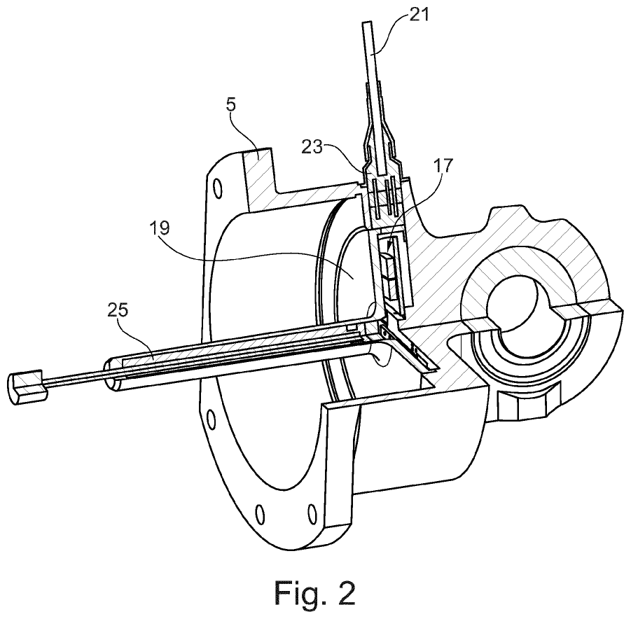

FIG. 2 is a first view in perspective and in section of an instrumented end piece of an electromechanical actuator according to the present invention;

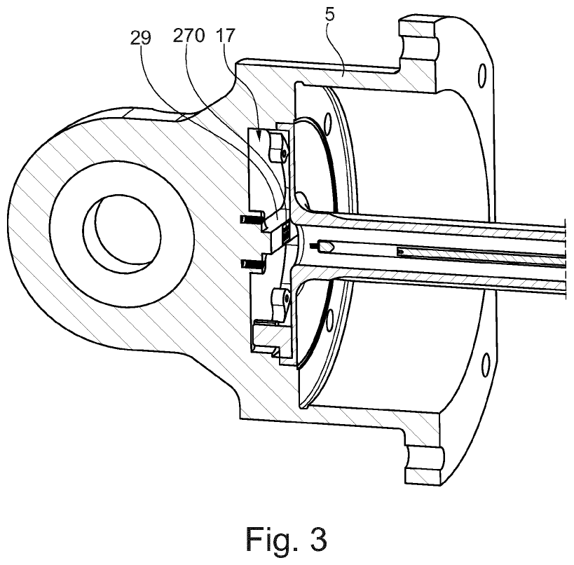

FIG. 3 is a second view in perspective and in section of an instrumented end piece of an electromechanical actuator according to the present invention;

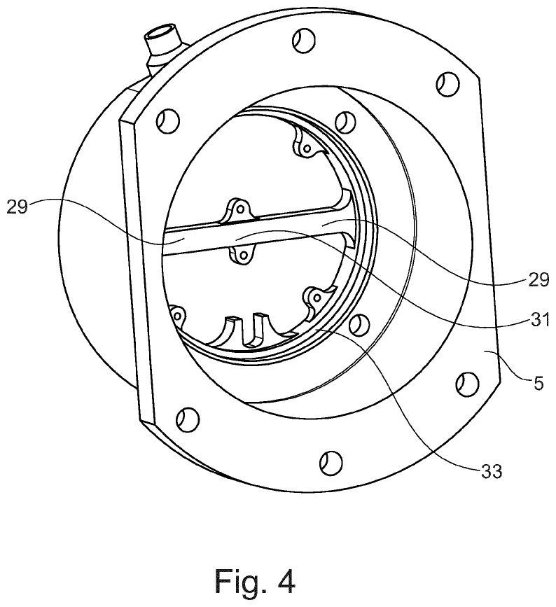

FIG. 4 is a view in perspective of an instrumented end piece of an electromechanical actuator according to the present invention;

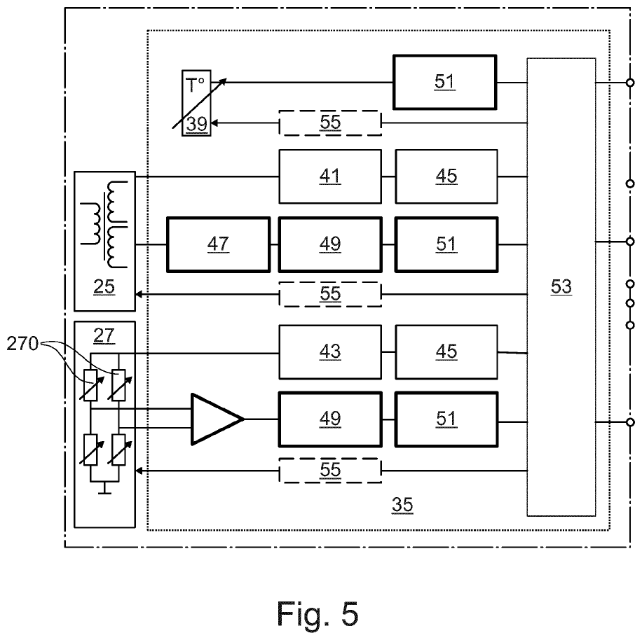

FIG. 5 is a schematic view of a processing unit of an instrumented end piece of an electromechanical actuator according to the present invention;

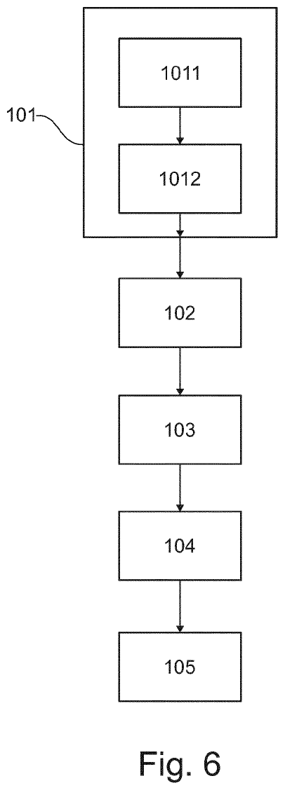

FIG. 6 is a flow diagram of the steps of a manufacturing method for manufacturing an electromechanical actuator end piece according to the present invention.

In these figures, identical elements bear the same reference numerals.

The following embodiments are examples. Although the description refers to one or more embodiments, this does not necessarily mean that each reference relates to the same embodiment or that the features apply only to a single embodiment. Single features of different embodiments can also be combined or interchanged to provide further embodiments.

The present invention relates to an electromechanical actuator, notably for an aircraft and notably a measurement device designed to be arranged in such an electromechanical actuator.

FIG. 1 shows a view in section of such an electromechanical actuator 1.

The electromechanical actuator 1 comprises an electric motor 3 comprising a stator 3a and a rotor 3b. The electric motor 3 is arranged in a metal structure 5 forming a protective housing of the electric motor 3. The metal structure 5 has, for example, an elongated shape, notably a cylindrical shape and can be formed by a first part 5a and a second part 5b. The metal structure 5 is produced from steel or from aluminum, for example. The metal structure 5 also comprises a first fixing element 7 which is arranged, for example, on the first part 5a of the metal structure 5. The first fixing element 7 comprises, for example, a pivot connection produced by an annular bearing or a ball joint produced by a spherical bearing 70.

The electromechanical actuator 1 also comprises a movable member 9 which is mobile in translation along a longitudinal axis of the electromechanical actuator 1. The movable member 9 protrudes from a second part 5b of the metal structure 5 on the side opposing the first part 5a.

The movable member 9 is configured to be moved by the electric motor 3, for example via a ball screw 11 arranged between the rotor 3b of the electric motor 3 and the movable member 9. The ball screw 11 makes it possible to transform the rotational movement of the rotor 3b of the electric motor 3 into a translation movement of the movable member 9, while limiting friction. However, other devices can be used to permit the movement of the movable member 9 from the rotation of the rotor 3b of the electric motor 3, notably a simple screw-nut assembly.

The movable member 9 also comprises a second fixing element 13 which can be similar to the first fixing element 7 but can also be different. The first fixing element 7 can comprise, for example, a pivot connection and the second fixing element 13 can comprise a ball joint or vice versa. In the example of FIG. 1, the first fixing element 7 and the second fixing element 13 are identical and each comprise a spherical bearing 70.

The electromechanical actuator 1 also comprises bearings 12 for guiding the mobile element 9 and bearings 14 for guiding the rotor 3b of the electric motor 3.

The electromechanical actuator can also comprise stops 16 for stopping the mobile element 9.

The electromechanical actuator 1 also comprises a measurement device 15 for measuring the movements of the movable member 9. This measurement device 15 is arranged, for example, in an internal housing 17 (visible in FIGS. 2 and 3) of the metal structure 5. The internal housing 17 is arranged, for example, in the first part 5a of the metal structure 5. The first part 5a of the metal structure and the measurement device 15 form an end piece of the electromechanical actuator 1. The present invention also relates to such an electromechanical actuator end piece 1.

The internal housing 17 is closed, for example, by a metal cover 19. The metal cover 19 is for example welded, notably by electron beam or by laser welding, to the metal structure 5 to form an internal housing 17 which is hermetic, i.e. which prevents any passage of air, or is sealed, i.e. which prevents any passage of water. The passage of the cables 21 connecting the measurement device 15 and the outside of the metal structure 5 is implemented, for example, via a hermetic or sealed connector 23 or connection.

Obtaining a hermetic connection or connector 23 is achieved, for example, via a seal with glass beads. A sealed connection or connector is obtained, for example, by the application of a coating formed, notably, by an adhesive around the connector or the cable (in the case of a sealed connection).

The measurement device 15 comprises a position sensor 25, for example a Linear Variable Differential Transformer (LVDT) as in the various figures. Other types of position sensor can also be used.

In the example shown, the position sensor of the LVDT type comprises a plurality of coils forming, on the one hand, a primary winding configured to be powered by an alternating voltage and, on the other hand, two secondary windings, a ferromagnetic core being arranged in the center thereof. The ferromagnetic core is configured to be moved with the movable member 9 so that the movement of the movable member 9 varies the voltage induced in the secondary windings. This technology permits a reliable and contactless measurement of the position, which makes it possible to maximize the service life of the position sensor 25.

The measurement device 15 also comprises a force sensor 27 which is configured to measure the force applied by the electromechanical actuator 1.

The force sensor 27 is implemented, for example, by strain gauges 270 arranged on one or more test bodies 29 arranged within, or in the vicinity of, the force path, i.e. configured to be deformed as a function of the force applied by the electromechanical actuator 1.

The test body or the test bodies 29 are, for example, directly formed or machined in the metal structure 5 and notably in the housing 17 of the first part 5a of the metal structure 5. As shown in FIG. 4, the metal structure 5 is machined, for example, to form a central element 31 which is connected to a peripheral zone 33 via a plurality of arms or cross-members 29 extending radially and forming the different test bodies. Alternatively, the test body or the test bodies can be formed by cavities created directly in the metal structure 5.

The measurement device 15 also comprises a processing unit 35 configured to process the signals from the position sensor 25 and/or from the force sensor 27. The processing unit 15 is also configured to be arranged in the housing 17.

In the case where the processing unit 35 only processes the signals from the position sensor 25, the signals from the force sensor 27 are transmitted directly to the outside of the electromechanical actuator 1, for example via the hermetic connector 23.

In the case where the processing unit 35 only processes the signals from the force sensor 27, the signals from the position sensor 25 are transmitted directly to the outside of the electromechanical actuator 1, for example via the hermetic connector 23.

The measurement device 15 can also comprise a temperature sensor 39. The temperature sensor is, for example, a thermocouple or a thermistor.

FIG. 5 shows an exemplary embodiment of a processing unit 35.

In the case of FIG. 5, the temperature sensor 39 is arranged in the processing unit 35 but the temperature sensor 39 can also be external relative to the processing unit 35. The processing unit 35 is configured to apply a temperature compensation of the measurements of the position sensor 25 and/or the force sensor 27.

The processing unit 35 comprises means 41 for shaping a power supply signal of the position sensor 25, for example to supply power to the primary winding of the position sensor 25, for example by a sinusoidal voltage and/or means 43 for shaping a power supply signal of the force sensor 27, for example to supply power to a Wheatstone bridge in which the strain gauges 270 are arranged, by a direct voltage. These power supply signals can be generated from a common power supply 45, for example a 15V DC power supply.

The common power supply 45 is obtained via an electrical cable connected to the hermetic connector 21 and configured to transmit an electrical power supply current. Moreover, in order to reduce the number of cables between the processing unit 35 and the exterior of the metal structure 5, the electrical potential associated with the electrical power supply current can be by carrier current, the modulation thereof enabling the output signals from the position sensor 25 and/or force sensor 27 and/or temperature sensor 39 to be calibrated digitally.

The processing unit 35 can also comprise demodulation means 47 for demodulating the signals from the position sensor 25, digital-analog converters 49 designed for the calibration, filters, notably low-pass filters 51 or electromagnetic interference and electromagnetic compatibility filters 53 or other electronic components useful for supplying power to or processing the signals from the position sensor 25 and/or force sensor 27.

The processing unit 35 can also be configured to carry out self-test functions on the different sensors 25, 27 and 39. The self-test is carried out, for example, when a self-test command is received by the processing unit 35 from outside the electromechanical actuator 1. The self-test consists, for example, in placing the electromechanical actuator in a predefined state (or a succession of predefined states) and verifying that the measurements provided by the sensors in this or these predefined state(s) are within a predefined measurement interval. Carrying out such a self-test permits the verification of the correct operation of the position and/or force and/or temperature measurement chain via an external command.

The processing unit 35 can also be configured to apply the functions of monitoring the correct operation of the position sensor 25 and/or force sensor 27 and/or temperature sensor 39 via self-tests at predetermined times (for example when energizing the electromechanical actuator 1 or at regular or predefined time intervals).

The processing unit 35 can be arranged on a single printed circuit board (PCB) to limit its bulk.

Thus the measurement device 15 comprising the position sensor 25 and/or force sensor 27 and/or temperature sensor 39 and/or the processing unit 35 is arranged in the internal housing 17 which makes it possible to improve the immunity of the electromechanical actuator 1 relative to electromechanical interference.

This integration of the processing unit 35 inside the electromechanical actuator 1 in the vicinity of the position sensor 25 and the force sensor 27 makes it possible to eliminate connecting cables between the sensors 25 and 27 and an external processing unit which makes it possible, notably, to reduce the bulk of these sensors 25 and 27 and, notably, the diameter of the position sensor 25, which makes it possible to reduce the diameter of the electromechanical actuator 1. The elimination of the connecting cables between the sensors 25 and 27 and the processing unit 35 also makes it possible to reduce losses associated with the transmission of signals, which makes it possible to improve the accuracy of the measurements.

Thus the integration of a measurement device 15 comprising a position sensor 25, a force sensor 27 and a processing unit 35 in an electromechanical actuator 1 makes it possible not only to provide an electromechanical actuator 1 which is usable in an aircraft since it provides precise measurements of position and force, but also to protect the measurement device 15 from the environment due to the positioning of the measurement device 15 in a hermetic or sealed internal housing 17. This also makes it possible to reduce the bulk of the electromechanical actuator 1, notably the external diameter of the electromechanical actuator 1.

The integrated position sensor 25 and force sensor 27 and even the temperature sensor 39 also make it possible to detect effectively a problem or a failure in the region of the electromechanical actuator 1 and notably a seizure, for example of the screw-nut system 11, leading to an abnormal force variation for a given position variation or an abnormal temperature increase. The self-test function also makes it possible to detect a failure of the position sensor 25 or the force sensor 27 or the temperature sensor 39.

Such an integration of the measurement device 15 and, notably, the processing unit 35 makes it possible to reduce the number of connecting wires between the inside and outside of the electromechanical actuator 1, to simplify the interface with the sensors 25 and 27, to simplify the reception of measurements associated with the sensors 25 and 27 and to reduce the overall power consumption of the electromechanical actuator 1.

The present invention is not limited to the described embodiment but can also be applied to other types of electromechanical actuators, notably rotary electromechanical actuators. In the case of a rotary electromechanical actuator, the torque provided by the electric motor can be used directly or via a reducer, the position sensor is, for example, a rotary variable differential transformer (RVDT) and the torque sensor can also be implemented by strain gauges arranged in the force path and configured to be deformed by the action of a torque provided by the electric motor. Further types of position sensor or force sensor can also be used.

The present invention also relates to a manufacturing method for manufacturing an end piece of an electromechanical actuator 1 as described above.

FIG. 6 shows the different steps of this manufacturing method.

The first step 101 relates to a machining step for machining a part 5a of a metal structure 5, for example made of steel, of the electromechanical actuator 1 in order to form an end piece of the electromechanical actuator 1.

This first step 101 comprises a first sub-step 1011 for producing an internal housing 17 formed in the first part 5a of the metal structure 5. The internal housing 17 is configured to receive a measurement device 15 as described above.

The first step 101 also comprises a second sub-step 1012 for producing one or more test bodies directly in the metal structure 5. The test body is produced, for example, by a central element 31 connected to a peripheral zone 33 via a plurality of cross-members 29 extending radially to form different test bodies designed to receive the strain gauges 270 of the force sensor 27. Alternatively, one or more cavities can be created to form the test body or the test bodies.

The second step 102 relates to a machining step for machining a metal block, for example made of steel, to provide a metal cover 19 comprising a base 19a, for example in the shape of a disk, and a tube 19b corresponding to the external body of the position sensor 25 extending perpendicularly to the plane of the base 19a on a first side of the base 19a.

The third step 103 relates to the assembly of a sliding rod protruding from the end of the tube 19b of the metal cover 19. This sliding rod comprises the ferromagnetic core of the position sensor 25 and is configured to be connected to the movable 9.

The fourth step 104 relates to the mounting of the measurement device 15, i.e. the position sensor 25 and the force sensor 27, and even the temperature sensor 39, and the processing unit 35 in the internal housing 17. An internal housing part 17 is located in the metal cover 19.

The fifth step 105 relates to the fixing of the metal cover 19 to the metal structure 5 by welding in order to close the internal housing 17. The welding is carried out, for example, by electron beam or by laser.

The order of the steps of the manufacturing method can be different from the order shown and some of the steps of the manufacturing method shown can be optional or replaced by other manufacturing steps.

1. An electromechanical actuator end piece for an aircraft, comprising a first part of a metal structure of an electromechanical actuator in which a measurement device is arranged, the electromechanical actuator comprising:
an electric motor arranged in the metal structure; and
a movable member configured to be moved by the electric motor,
wherein the measurement device comprises:
a position sensor for detecting a position of the movable member,
a force sensor configured to measure a force applied by the electromechanical actuator and comprising a plurality of strain gauges arranged on at least one test body, which is configured to be deformed as a function of the force applied by the electromechanical actuator, and the at least one test body is formed directly in the metal structure of the electromechanical actuator, and
a processing unit for processing signals from the position sensor and/or from the force sensor.

2. The electromechanical actuator end piece of claim 1, wherein the measurement device also comprises a temperature sensor, and wherein the processing unit is also configured to process signals from the temperature sensor.

3. The electromechanical actuator end piece of claim 1, wherein the position sensor is a variable differential transformer comprising a plurality of coils forming a primary winding and two secondary windings, a ferromagnetic core, which is configured to be moved with the movable member, being arranged in a center thereof.

4. The electromechanical actuator end piece of claim 1, wherein the processing unit is configured to apply a thermal compensation to measurements of the position sensor and/or the force sensor.

5. The electromechanical actuator end piece of claim 1, wherein the processing unit is arranged in a hermetic or sealed housing of the metal structure.

6. The electromechanical actuator end piece of claim 5, comprising a hermetic connection or a hermetic connector, which is configured to provide an electrical connection between the processing unit and an outside of the metal structure, wherein the hermetic connection or the hermetic connector comprising a seal with glass beads.

7. The electromechanical actuator end piece of claim 2, wherein the processing unit is configured to calibrate digitally the position sensor and/or the force sensor and/or the temperature sensor by carrier current via power supply cables of the processing unit in order to limit a number of cables between the processing unit and an outside of the metal structure.

8. The electromechanical actuator end piece of claim 1, wherein the processing unit is configured to apply a self-test of the position sensor and/or the force sensor to verify correct operation thereof in response to reception of an external command.

9. The electromechanical actuator end piece of claim 1, wherein the first part comprises a hermetic or sealed housing.

10. The electromechanical actuator end piece of claim 9, comprising a metal cover, which is configured to close the hermetic or sealed housing, the metal cover being welded to the first part of the metal structure.

11. An electromechanical actuator comprising:
an electric motor arranged in a metal structure;
a movable member configured to be moved by the electric motor;
an electromechanical actuator end piece comprising: a first part of the metal structure and a measurement device comprising: a position sensor for detecting a position of the movable member, a force sensor configured to measure a force applied by the electromechanical actuator and comprising a plurality of strain gauges arranged on at least one test body, which is configured to be deformed as a function of the force applied by the electromechanical actuator, and the at least one test body is formed directly in the metal structure of the electromechanical actuator, and a processing unit for processing signals from the position sensor and/or from the force sensor; and
a second part of the metal structure.

12. A manufacturing method for manufacturing an electromechanical actuator end piece of an electromechanical actuator having a movable member movable by an electric motor, wherein the electromechanical actuator end piece comprises: a first part of a metal structure of the electromechanical actuator and a measurement device comprising: a position sensor for detecting a position of the movable member, a force sensor configured to measure a force applied by the electromechanical actuator and comprising a plurality of strain gauges arranged on at least one test body, which is configured to be deformed as a function of the force applied by the electromechanical actuator, and the at least one test body is formed directly in the metal structure of the electromechanical actuator, and a processing unit for processing signals from the position sensor and/or from the force sensor, and wherein the manufacturing method comprises:
a machining step for machining the metal structure to form one or more zones forming a test body, which is configured to receive the strain gauges.

13. The manufacturing method of claim 12, wherein the first part comprises a hermetic or sealed housing, wherein the electromechanical actuator end piece further comprises a metal cover configured to close the hermetic or sealed housing, the manufacturing method further comprising:
a welding step for welding the metal cover to the metal structure by electron beam or laser welding.
